(19) United States
(12) Patent Application Publication
(10) Pub. No.: US 2013/0076511 A1
(43) Pub. Date: Mar. 28, 2013

(54) RESONATOR DESIGN FOR DETECTORS AND SOUNDERS

(71) Applicants: Arthur Blanc, Providence, RI (US); Virginia H. Faustino, New Haven, CT (US); Antonio M. Vincitore, South Windsor, CT (US); Joseph B. Wysocki, Somers, CT (US); Christopher T. Chipman, Killingly, CT (US); Daniel W. Shannon, Glastonbury, CT (US)

(72) Inventors: Arthur Blanc, Providence, RI (US); Virginia H. Faustino, New Haven, CT (US); Antonio M. Vincitore, South Windsor, CT (US); Joseph B. Wysocki, Somers, CT (US); Christopher T. Chipman, Killingly, CT (US); Daniel W. Shannon, Glastonbury, CT (US)

(73) Assignee: UTC FIRE & SECURITY CORPORATION, Farmington, CT (US)

(21) Appl. No.: 13/247,172

(22) Filed: Sep. 28, 2011

(51) Int. Cl. G08B 21/00; G10K 11/30; G10K 11/00

(52) U.S. Cl. 340/540; 181/175; 181/176

(57) ABSTRACT

A sound enhancement device for a detector includes a cylindrical portion having a tubular body and an interior cavity longitudinally coextensive therewith. The device includes a first elongated portion and at least a second elongated portion with both portions coupled to the cylindrical portion. The first elongated portion includes a first body portion having a first cavity that is coextensive with the first body portion while the at least second elongated portion includes a second body portion having a second cavity that is coextensive with the second body portion. The cylindrical portion and each of the first and at least the second elongated portions comprise a length of a quarter wavelength of a predefined frequency. The sound enhancement device includes radii of curvatures for causing a wavefront emanating from the sound enhancement device to maximize the radiation efficiency of the sound enhancement device.

### FIELD OF INVENTION

The subject matter disclosed herein relates generally to the field of generating audible signals, and more particularly, to a resonator which is sized and configured for use with an audible alert device such as a detector or sounder.

### DESCRIPTION OF RELATED ART

A variety of commercially available alert devices such as detectors or sounders exist for alerting individuals of the presence of smoke, heat, and/or carbon monoxide, among other things. These devices are typically designed to be mounted to the ceiling in various rooms of a house or other building, and are powered by either a battery or the building's power lines. The audible alert signals generated by such devices are governed by various standards and regulations such as, for example, Underwriters Laboratories (UL) 217 standards. According to these UL217 standards, a typical smoke detector produces a 3100-3200 Hz pure tone alert signal with the intensity (or power) of 45 to 120 dB. These alert signals are generated using a piezoelectric device or a speaker. However, 3100-3200 Hz alert signals generated by existing detectors/sounders are sometimes inadequate for alerting certain classes of individuals, such as children, heavy sleepers, and the hearing impaired.

Accordingly, a change in the UL 217 standards to take effect in 2014 will require detectors/sounders to emit a relatively low-frequency 520 Hz square-wave alert signal, or a signal with similar characteristics for fire alarms installed in residential bedrooms of those with mild to severe hearing loss, and in commercial sleeping rooms. However, it is much harder to generate the required sound levels at 520 Hz with a high efficiency detector (i.e., low current drain) in a compact enclosure.

### BRIEF SUMMARY

According to one aspect of the invention, a sound enhancement device for a detector includes a cylindrical portion having a tubular body from an open first end to an opposed second end and an interior cavity longitudinally coextensive with the tubular body; a first elongated portion coupled to the cylindrical portion, the first elongated portion including a first body portion having a first cavity that is coextensive with the first body portion, the first body portion extending from an open third end to an open fourth end; and at least a second elongated portion coupled to the cylindrical portion, the at least second elongated portion including a second body portion having a second cavity that is coextensive with the second body portion, the second body portion extending from an open fifth end to an open sixth end. Also, the third end is coupled to the second end to create a continuous opening from the first cavity and the interior cavity while the fifth end is coupled to the second end to create a continuous opening from the second cavity and the interior cavity. The cylindrical portion and each of the first and at least the second elongated portions are a length of a quarter wavelength of a predefined frequency.

According to another aspect of the invention, a sound enhancement system for use in a detector assembly includes a detection device configured for detecting an alarm condition and generating an alarm signal; signal processing circuitry configured for receiving the alarm signal and generating an output signal indicative of the alarm condition; a sound generating device coupled to a sound enhancement device, the sound generating device configured for receiving the output signal and outputting an audible alert signal into the sound enhancement device. Also, the sound enhancement device includes a cylindrical portion having a tubular body from an open first end to an opposed second end and an interior cavity longitudinally coextensive with the tubular body; a first elongated portion coupled to the cylindrical portion, the first elongated portion including a first body portion having a first cavity that is coextensive with the first body portion, the first body portion extending from an open third end to an open fourth end; and at least a second elongated portion coupled to the cylindrical portion, the at least second elongated portion including a second body portion having a second cavity that is coextensive with the second body portion, the second body portion extending from an open fifth end to an open sixth end. Further, the third end is coupled to the second end to create a continuous opening from the first cavity and the interior cavity while the fifth end is coupled to the second end to create a continuous opening from the second cavity and the interior cavity. The cylindrical portion and each of the first and at least the second elongated portions are a length of a quarter wavelength of a predefined frequency.

Other aspects, features, and techniques of the invention will become more apparent from the following description taken in conjunction with the drawings.

### BRIEF DESCRIPTION OF THE SEVERAL VIEWS OF THE DRAWINGS

Referring now to the drawings wherein like elements are numbered alike in the several FIGURES:

FIG. 1 illustrates a phantom perspective view of an embodiment of a detector assembly including a sound enhancement device housed inside the assembly according to an embodiment of the invention;

FIG. 2 illustrates a partial exploded side view of the detector assembly shown in FIG. 1, the sound enhancement device located in a lower enclosure according to an embodiment of the invention;

FIG. 3A illustrates a perspective view of the sound enhancement device shown in FIGS. 1-2 according to an embodiment of the invention;

FIG. 3B illustrates a partial top view of the sound enhancement device of FIGS. 1-3A shown with pressure wavefronts emanating from the ducts according to an embodiment of the invention;

FIG. 4 illustrates a partial perspective view of a sound enhancement device integrated with a lower enclosure in a detector assembly according to an embodiment of the invention; and

FIG. 5 illustrates a perspective view of a sound enhancement device according to an embodiment of the invention.

### DETAILED DESCRIPTION

Embodiments of a sound enhancement device to amplify sound in a detector or sounder assembly includes a cylindrical portion coupled to at least one tubular portion having a uniform rectangular cross-section along its length. The sound enhancement device is located within an interior cavity of the detector or sounder assembly and is provided to receive a sound-generating device that partially resides within the cylindrical portion. The at least one tubular portion is configured for amplifying comparatively weak audible sounds produced by the sound-generating device by causing a column of air inside the tubular portion to resonate as a function of the fundamental frequency of the audible sound produced by the sound-generating device. The sound enhancement device therefore amplifies the sound level emanating from the at least one tubular portion without requiring additional power to be supplied to the detector or alert device.

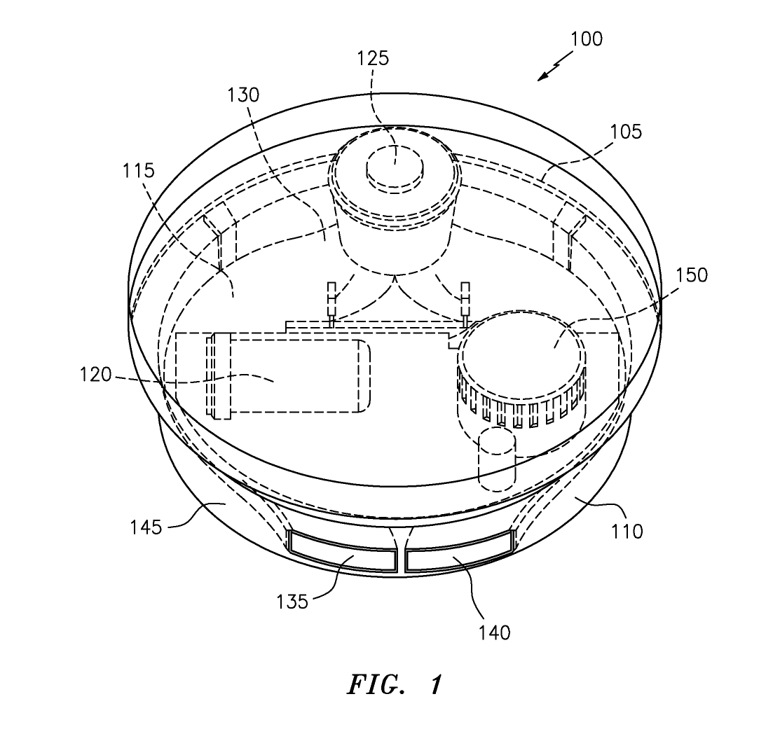

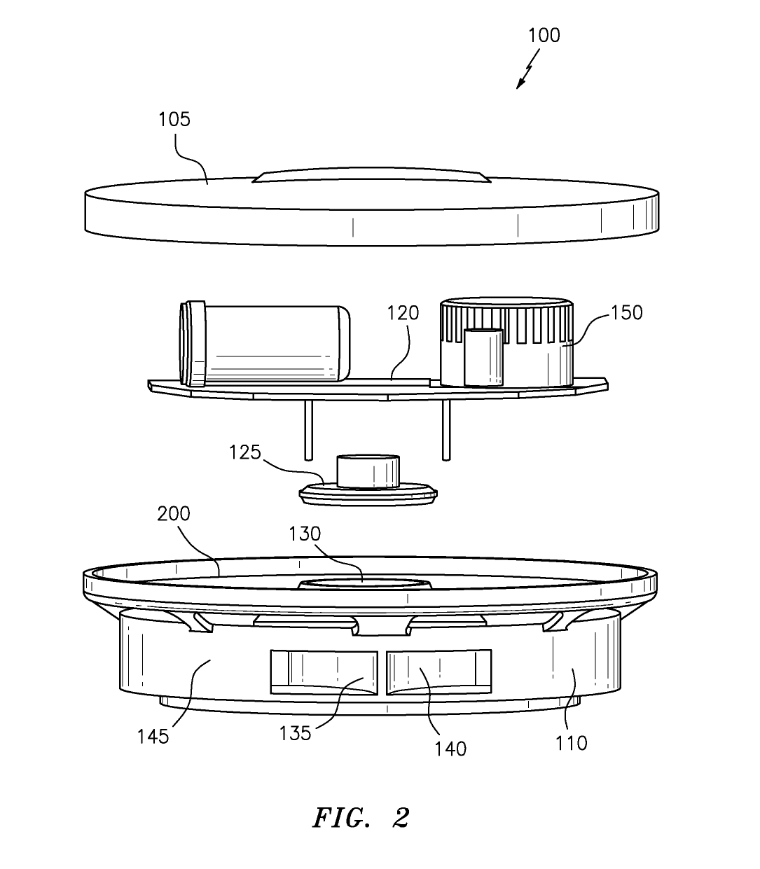

Referring now to the drawings, FIGS. 1-2 illustrate a detector assembly 100 having a sound enhancement device 130 coupled to a sound generating device 125 according to an embodiment of the invention. As shown, the detector assembly 100 includes a generally cylindrical top enclosure 105 configured for coupling to a generally cylindrical bottom enclosure 110. The enclosures 105, 110 cooperatively couple to each other, which provide an interior cavity 115 for receiving a control board 120 having signal-processing circuitry, an amplifier (not shown) and a detection device 150. In one example, the detection device may be an ionization chamber in order to generate signals indicative of an alarm condition such as, in some non-limiting examples, smoke, carbon monoxide, heat, or other similar conditions detected by the detection device 150. The control board 120 is electrically coupled to a sound generating device 125 for generating an audible sound or alarm, which is enhanced through the sound enhancement device 130. In embodiments, a speaker, a buzzer, a piston, a piezoelectric device or other similar types of sound-generating devices may be used as the sound generating device 125. The sound enhancement device 130 is aligned with the lower enclosure 110 for transmitting audible sound via a plurality of openings 135, 140 that are circumferentially provided along the sidewall 145 of lower enclosure 110. In operation, the signal processing circuitry on control board 120 is configured for detecting smoke, heat, carbon monoxide, or some combination thereof and subsequently generating an audible sound with the sound generating device 125 after an alarming condition is detected. The comparatively weak audible sound that is produced is directed through the sound enhancement device 130 causing the comparatively weak sound to resonate and substantially increase in loudness as it exits the detector assembly 100 through the openings 135, 140.

In an embodiment, as shown in FIG. 2, both the sound enhancement device 130 and the control board 120 are provided to be operably connected together for being contained substantially within an enclosed cavity 200 of bottom enclosure 110 in order to maximize the acoustic sound emanating from the sound enhancement device 130 as well as providing for a compact detector assembly 100. In another embodiment, the sound enhancement device 130 and control board 120 may be rotated upside down so that sound enhancement device 130 resides within the top enclosure 105, thereby providing for an alternate layout of batteries and electronic components within detector assembly 100 without detracting from the scope of the invention.

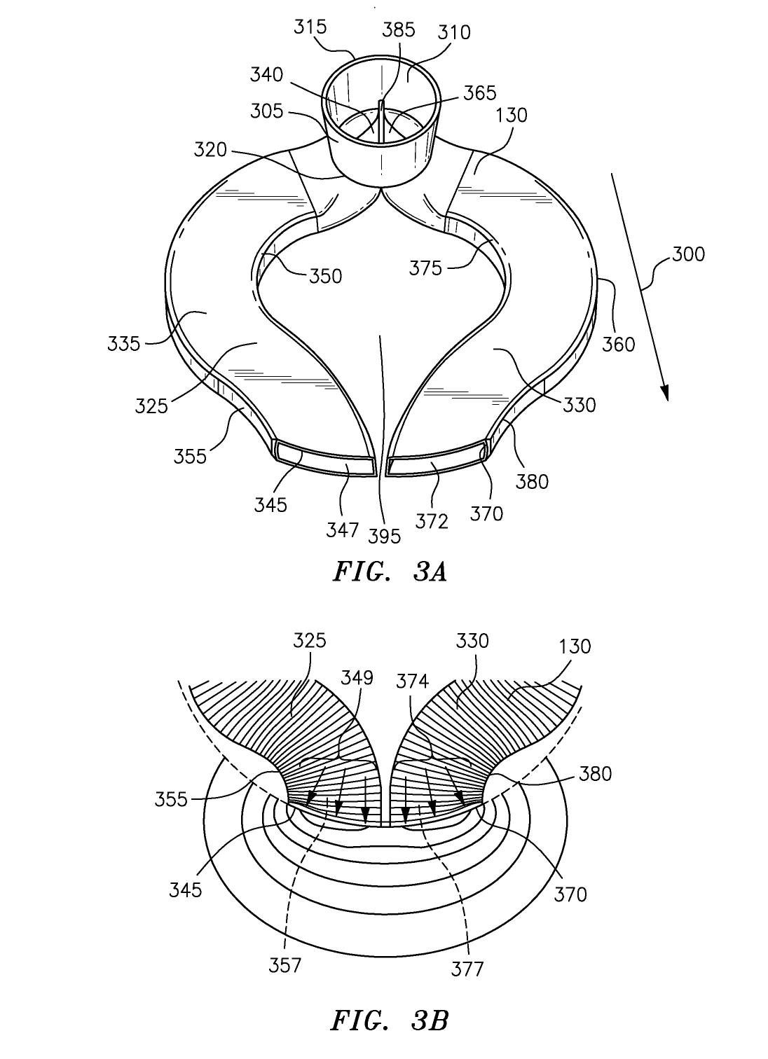

FIGS. 3A-3B illustrate a detailed view of the configuration of the sound enhancement device 130 having resonators 325, 330 for sound amplification according to an embodiment of the invention. Particularly, as shown in FIG. 3A, sound enhancement device 130 is provided to follow the contours of the sidewall 145 (FIG. 2) of lower enclosure 110 (FIG. 2) as well as to amplify the sound level emanating from openings 347, 372 that are aligned with openings 135, 140 in the detector assembly 100 (FIG. 1). In one embodiment, the sound enhancement device 130 is generally “heart-shaped” and includes a tubular portion 305 coupled to a plurality of duct portions 325, 330 (collectively referred to as “quarter wavelength resonators” from tubular portion 305 to each resonator 325, 330). Also, tubular portion 305 has an interior cavity 310 that is longitudinally coextensive with the length of tubular portion 305 (i.e., portion 305 is cannulated). Also, in an example, the tubular portion 305 includes a splitting partition wall that splits the interior cavity 310 into multiple cavities. In one embodiment, portion 305 is tapered having a first larger circumferential diameter at end 315 and a second smaller circumferential diameter at end 320. In another embodiment, portion 305 may have a uniform cross-section from end 315 to end 320. Also, end 315 is open while end 320 is coupled to, in one example, the resonators 325, 330. The tubular portion 305 is provided for receiving a sound-generating device 125 (FIGS. 1-2) at end 315 and causing a pressure wavefront of the audible alarm, produced by the sound-generating device 125 (FIGS. 1-2), to travel from the interior cavity 310 and resonate at a particular frequency as it passes through the resonators 325, 330. It is also to be appreciated that an additional resonator that is substantially similar to resonators 325, 330 as well as a helmholtz resonator may be coupled to the tubular portion 305 in order to amplify sound at different discrete frequencies as well as being tuned to produce an audible sound at the same discrete frequency.

As shown in FIG. 3A, resonators 325, 330 are substantially similar in shape, and configured for exciting a column of air in resonance inside an enclosed elongated cavity, thereby greatly increasing the sound level. Particularly, resonator 325 is cannulated and includes a generally curved body portion 335 (or duct 335) that emanates at end 340 and terminates at a curved open end 345 along direction 300. Also, body portion 335 encloses an interior cavity longitudinally coextensive to body portion 335 and includes a first radius of curvature 350 terminating into a second radius of curvature 355 in order to improve the radiation efficiency of the resonator 325. Particularly, and as shown in more detail in FIG. 3B, the second radius of curvature 355 is provided to cause the pressure wavefront 357 for the acoustic energy traveling through the resonator 325 to be substantially parallel and aligned to the exposed surface of the curved open end 345, causing a tangent of a plane of the pressure wavefront 357 to be substantially orthogonal to a tangent of a plane of the curved open end 345 as it exits the curved open end 345, as is shown with directional arrows 349. As such, the radii of curvature 350, 355 (FIG. 3A) are utilized to maximize the acoustic energy emanating from resonator 325 and provides for a compact quarter wavelength resonator that is able to maximize the available dimensions of the interior cavity 200 (FIG. 2) of bottom enclosure 110 (FIGS. 1-2).

Also shown in FIG. 3A, resonator 330 is substantially similar to resonator 325, which was shown and described in FIG. 3A, and is cannulated and includes a generally curved body portion 360 (or duct 360) emanating at end 365 and terminating at a curved open end 370 along direction 300. Further, body portion 360 encloses an interior cavity longitudinally coextensive to body portion 360 and includes a first radius of curvature 375 terminating into a second radius of curvature 380 in order to improve the radiation efficiency of the resonator 330. Particularly, and as shown in more detail in FIG. 3B, the second radius of curvature 380 is provided to cause the pressure wavefront 377 for the acoustic energy traveling through the resonator 330 to be substantially parallel and aligned to the exposed surface of the curved open end 370, causing a tangent of a plane of the pressure wavefront 377 to be substantially orthogonal to a tangent of a plane of the curved open end 370 as it exits the curved open end 370, as is shown with directional arrows 374. As such, the radii of curvature 375, 380 are utilized to maximize the acoustic energy emanating from resonator 330 and provides for a compact quarter wavelength resonator that is able to maximize the available dimensions of the interior cavity 200 (FIG. 2) of bottom enclosure 110 (FIGS. 1-2).

In one embodiment, shown in FIG. 3A, the bottom surfaces of each resonator 325, 330 reside on a common plane. Resonators 325, 330 are coupled together at respective ends 340, 365 by a deflecting lens 385, which transitions the interior cavity 310 into the ducts 335, 360 at end 320. The resonators 325, 330 are coupled to form an opening 395 between the resonator bodies 335, 360, which is provided to receive, in embodiments, a housing for a battery or an A/C power supply to power the detector assembly 100 (FIG. 1-2). In an embodiment, additional resonators, such as resonator 325, 330 may be provided and coupled to tubular portion 305 in order to increase the volume of the audible sound generated by sound-generating device 125 (FIGS. 1-2). It is to be appreciated that resonators 325 and 330 are portions of quarter-wavelength resonators and are configured for vibrating sound, within the portion 305 and the ducts 305, 335, 360, in resonance as a function of the fundamental frequency and its harmonics. Accordingly, the portion 305 and the resonators 325, 330 are tuned to have a length that is approximately a quarter of a wavelength of the fundamental frequency of the audible sound produced by sound-generating device 125 (FIG. 2) from end 315 to curved open ends 345, 370. In one embodiment, the sound enhancement device 130 has an average length from end 315 to end 345 and from end 315 to end 370 respectively is about 6½ inches, which is a quarter of a wavelength of the fundamental frequency of about 540 Hz, and openings at ends 345, 370 are about 0.465 square-inches (300 square mm). In other embodiments, the length of from end 315 to respective ends 345, 370 may be dimensioned to be a quarter of a wavelength of the frequency in the range of 468 Hertz to 572 Hertz. It is to be appreciated that each duct portions 325, 330 may be tuned to the same frequency as well as to individual (discrete) frequencies. It is also to be appreciated that a third duct may be provided within detector assembly 100 (FIG. 1) that may be tuned at a harmonic frequency such as, for example, 1560 Hertz.

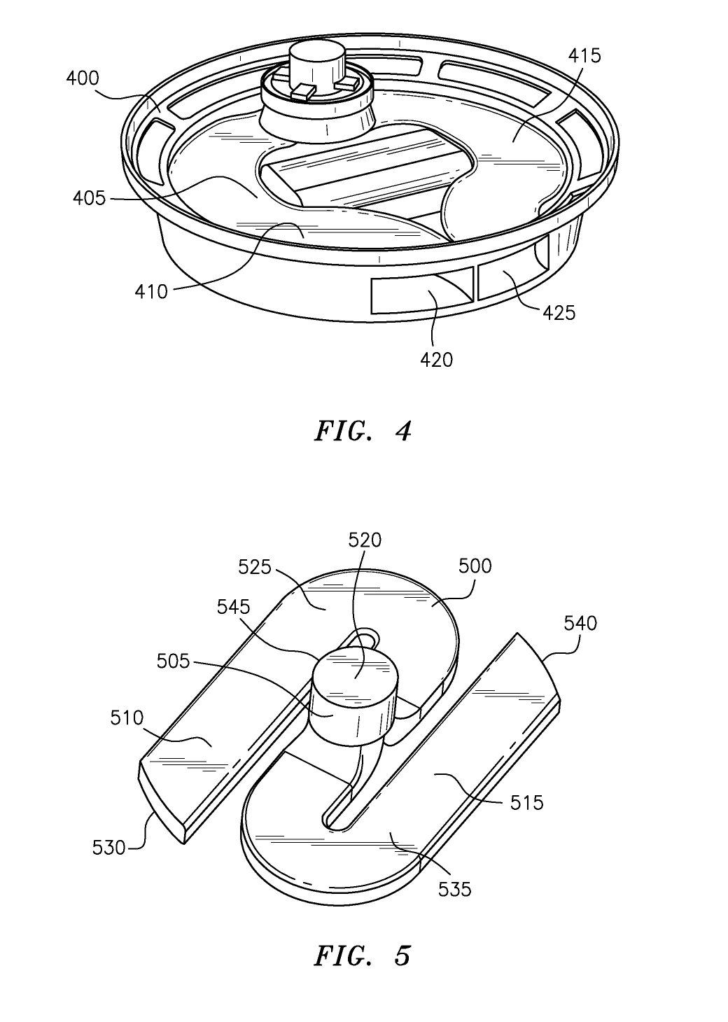

FIG. 4 illustrates a perspective view of a partial perspective view of a lower enclosure 400 integrated with a sound enhancement device 405 according to an embodiment of the invention. Particularly, lower enclosure 400 is molded together with the sound enhancement device 405 having a plurality of resonators 410, 415, while all other aspects of the sound enhancement device 405 remain substantially the same as the sound enhancement device 130 shown and described in FIG. 3. Resonators 410, 415 are substantially similar in shape and are configured for vibrating audible sound in resonance, thereby greatly increasing the loudness of the sound that emanates from openings 420, 425 respectively.

FIG. 5 illustrates a perspective view of a sound enhancement device 500 having resonators for sound amplification in a detector assembly according to an embodiment of the invention. Particularly, sound enhancement device 500 is generally “S-shaped” and includes a tubular portion 505 coupled to a plurality of resonators 510, 515. Portion 505 is configured for receiving a sound generating device 125 (FIG. 1-2) and amplifying an audible sound alarm produced by the sound generating device 125 (FIGS. 1-2) as the audible sound alarm ravels from the tubular portion 505 through the resonators 510, 515. Resonator 510 is cannulated and includes a duct 525 that emanates from interior cavity 520 and terminates at an open end 530. Similarly, resonator 515 is cannulated and includes a duct 535 that emanates from interior cavity 520 and terminates at an open end 540. Resonators 510, 515 are coupled together by a deflecting lens (not shown), which transitions the interior cavity 520 into the ducts 525, 535. It is to be appreciated that the resonators 510, 515 are portions of quarter-wavelength resonators and are configured for vibrating sound within the ducts 525, 535 in resonance as a function of the fundamental frequency. Accordingly, portion 505 and resonators 510, 515 have a length that is a quarter of a wavelength of the fundamental frequency of the audible sound produced by sound generating device 125 (FIGS. 2-3). In one embodiment, the sound enhancement device 500 has an average length from end 545 to end 530 and from end 545 to end 540 that is about 6½ inches, which is a quarter of a wavelength of the fundamental frequency of 520 Hz, and openings at ends 530, 540 are 0.465 square-inches (300 square mm). In other embodiments, the length of the resonators 510, 515 may be dimensioned such that the mean length between the plane parallel to open end 545 and each end 530, 540 to be a quarter of a wavelength of the frequency in the range of 468 Hertz to 572 Hertz. It is to be appreciated that each of the resonators 510, 515 may be tuned to the same frequency as well as to individual (discrete) frequencies. It is also to be appreciated that an additional third resonator as well as a helmholtz resonator may be provided that is tuned at a harmonic frequency such as, for example, 1560 Hertz.

The technical effects and benefits of exemplary embodiments include a sound enhancement device in a detector or alert device assembly to amplify sound and having at least one resonator located within an interior cavity of the detector/alert device assembly to receive comparatively low amplitude sounds and vibrate the sound in resonance within the at least one resonator to increase the loudness of the sound without the use of additional power drain from a power source.

The terminology used herein is for the purpose of describing particular embodiments only and is not intended to be limiting of the invention. While the description of the present invention has been presented for purposes of illustration and description, it is not intended to be exhaustive or limited to the invention in the form disclosed. Many modifications, variations, alterations, substitutions, or equivalent arrangement not hereto described will be apparent to those of ordinary skill in the art without departing from the scope and spirit of the invention. Additionally, while various embodiment of the invention have been described, it is to be understood that aspects of the invention may include only some of the described embodiments. Accordingly, the invention is not to be seen as limited by the foregoing description, but is only limited by the scope of the appended claims.

1. A sound enhancement device for a detector, comprising:
a cylindrical portion having a tubular body from an open first end to an opposed second end and an interior cavity longitudinally coextensive with the tubular body;
a first elongated portion coupled to the cylindrical portion, the first elongated portion including a first body portion having a first cavity that is coextensive with the first body portion, the first body portion extending from an open third end to an open fourth end; and
at least a second elongated portion coupled to the cylindrical portion, the at least second elongated portion including a second body portion having a second cavity that is coextensive with the second body portion, the second body portion extending from an open fifth end to an open sixth end;
wherein the third end is coupled to the second end to create a continuous opening from the first cavity and the interior cavity;
wherein the fifth end is coupled to the second end to create a continuous opening from the second cavity and the interior cavity; and
wherein the cylindrical portion and each of the first and at least the second elongated portions comprise a length of a quarter wavelength of a predefined frequency

2. The sound enhancement device of claim 1, wherein each of the first and second body portions are curved.

3. The sound enhancement device of claim 1, wherein the predefined frequency is between 468 Hertz and 572 Hertz.

4. The sound enhancement device of claim 1, wherein the predefined frequency is an odd harmonic frequency of about 520 Hertz.

5. The sound enhancement device of claim 3, wherein the predefined frequency is one of about 1560 Hertz, 2600 Hertz, or 3640 Hertz.

6. The sound enhancement device of claim 1, wherein the cylindrical portion includes a wall to transition the interior cavity into the first cavity and the second cavity.

7. The sound enhancement device of claim 6, wherein the second end is coupled to a deflecting lens for the transitioning of the interior cavity into the first cavity and the second cavity.

8. The sound enhancement device of claim 1, wherein the first body portion includes a first radius of curvature adjacent to the fourth end and a first curved opening at the fourth end, the first radius of curvature for causing a pressure wavefront emanating from the fourth end to be parallel to a tangent plane at a point in the first curved opening, thereby enhancing a resonance within the first cavity.

9. The sound enhancement device of claim 1, wherein the second body portion includes a second radius of curvature adjacent to the sixth end and a second curved opening at the sixth end, the second radius of curvature causing a pressure wavefront emanating from the sixth end to be parallel to a tangent plane at a point in the second curved opening, thereby enhancing a resonance within the second cavity.

10. The sound enhancement device of claim 1, wherein the first and at least the second elongated portions enclose a third cavity that is configured for receiving at least one of a battery housing or an alternating current power supply.

11. An alarm condition detector assembly, comprising
a detection device configured for detecting an alarm condition and generating an alarm signal;
signal processing circuitry configured for receiving the alarm signal and generating an output signal indicative of the alarm condition;
a sound generating device coupled to a sound enhancement device, the sound generating device configured for receiving the output signal and outputting an audible alert signal into the sound enhancement device, the sound enhancement device further comprising:
a cylindrical portion having a tubular body from an open first end to an opposed second end and an interior cavity longitudinally coextensive with the tubular body;
a first elongated portion coupled to the cylindrical portion, the first elongated portion including a first body portion having a first cavity that is coextensive with the first body portion, the first body portion extending from an open third end to an open fourth end; and
at least a second elongated portion coupled to the cylindrical portion, the at least second elongated portion including a second body portion having a second cavity that is coextensive with the second body portion, the second body portion extending from an open fifth end to an open sixth end;
wherein the third end is coupled to the second end to create a continuous opening from the first cavity and the interior cavity;
wherein the fifth end is coupled to the second end to create a continuous opening from the second cavity and the interior cavity; and
wherein the cylindrical portion and each of the first and at least the second elongated portions comprise a length of a quarter wavelength of a predefined frequency.

12. The alarm condition detector assembly of claim 11, wherein each of the first and second body portions is curved.

13. The alarm condition detector assembly of claim 11, wherein the predefined frequency is between 468 Hertz and 572 Hertz.

14. The alarm condition detector assembly of claim 11, wherein the predefined frequency is an odd harmonic frequency of about 520 Hertz.

15. The alarm condition detector assembly of claim 14, wherein the predefined frequency is one of about 1560 Hertz, 2600 Hertz, or 3640 Hertz.

16. The alarm condition detector assembly of claim 11, wherein the cylindrical portion includes a wall to transition the interior cavity into the first cavity and the second cavity.

17. The alarm condition detector assembly of claim 16, wherein the second end is coupled to a deflecting lens for the transitioning of the interior cavity into the first cavity and the second cavity.

18. The alarm condition detector assembly of claim 11, wherein the first body portion includes a first radius of curvature adjacent to the fourth end and a first curved opening at the fourth end, the first radius of curvature causing a pressure wavefront emanating from the fourth end to be parallel to a tangent plane at a point in the first curved opening, thereby enhancing a resonance within the first cavity.

19. The alarm condition detector assembly of claim 11, wherein the second body portion includes a second radius of curvature adjacent to the sixth end and a second curved opening at the sixth end, the second radius of curvature causing a pressure wavefront emanating from the sixth end to be parallel to a tangent plane at a point in the second curved opening, thereby enhancing a resonance within the second cavity.

20. The alarm condition detector assembly of claim 11, wherein the first and at least the second elongated portions enclose a third cavity that is configured for receiving at least one of a battery housing or an alternating current power supply.
